(19) United States
(12) Patent Application Publication
(10) Pub. No.: US 2008/0167403 A1
(43) Pub. Date: Jul. 10, 2008

(54) Antiadhesive Coating For Preventing Carbon Build-Up

(75) Inventor: Gunter Burkle, Benningen (DE)

Correspondence Address: YOUNG & BASILE, P.C., 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 11/816,355

(22) PCT Filed: Feb. 4, 2006
(86) PCT No.: PCT/EP2006/000989

§ 371 Date: Aug. 15, 2007

(30) Foreign Application Priority Data
Feb. 15, 2005 (DE) 10 2005 006 670.4

(51) Int. Cl. C08K 3/00

(52) U.S. Cl. 524/1

(57) ABSTRACT

A coating for a component coming into contact with carbon compounds, wherein the coating consists of a heat-resistant organic-inorganic hybrid polymer.

### BACKGROUND

The disclosure relates to a coating for a component which comes into contact with carbonaceous compounds.

Harmful deposits, such as carbon, form on components which come into contact with carbonaceous compounds. The carbon forms at temperatures between 180° C. (below that there is no coking) and about 380° C. (above this temperature the carbon is burned). The deposition of carbon, known as carbon buildup, takes place, for example, with pistons, valves and similar components of internal combustion engines in which an air/fuel mixture containing carbon is burned in the combustion chamber of an internal combustion engine in which the piston is located. Because of the prevailing temperatures, the carbon is not burned off, instead harmful carbon buildup occurs.

Measures are known from the prior art to attempt to prevent such carbon buildup on components which so far have all been unsatisfactory. An amorphous hydrated carbon coating containing silicon is known from EP 0 874 066 B1 which is produced by plasma precipitation. Plasma precipitation of this kind is involved and cost-intensive in the series production of components, when even the carbon coating described does not possess the desired properties. A coating composition for producing dirt repellant coatings is known from DE 100 04 132 A1, where the problem of carbon buildup is not mentioned. DE 101 18 352 A1 shows self-cleaning surfaces through hydrophobic structures, just as DE 101 06 213 A1 describes self-cleaning paint coatings and processes and means to produce same, although it is not mentioned here either that the surfaces come into contact with carbonaceous compounds.

### DETAILED DESCRIPTION

A coating is disclosed for a component which comes into contact with carbonaceous compounds with which the buildup of carbon is effectively prevented.

The coating consists of a heat-resistant organic-inorganic hybrid polymer. A coating of this type can be produced, for example, in a sol-gel process.

The organic-inorganic hybrid polymer is formed by pyrolyzable metal alkoxides and/or polymerizable organo-metallic compounds as precursors in organic solvents.

The metals may be from the group Si (silicon), Ti (titanium), Zr (zirconium), Al (aluminum), Sn (tin) or Ce (cerium) and others. These metals are completely or partially converted into oxides and sintered together in the course of pyrolysis at temperatures, in particular, in the combustion chamber so that the high-temperature resistant coating is created.

The coating is notable for excellent adhesion to the component and high thermal resistance. The inorganic-organic hybrid polymers, which themselves are poorly wettable by fluids and are thus anti-adhesive, can, for example, possess good anti-adhesive properties through the addition of perfluorated groups such as are known, for example, from the material Teflon. However, Teflon does have the disadvantage that its thermal limit of use is currently at about 300° C., whereas the use of the organic-inorganic hybrid polymers is unproblematic above this limit.

Furthermore, the desired anti-adhesive property can be achieved by nano-patterning the surface and the use of a poorly wettable material, resulting in the effect known in the scientific world as the “lotus effect.”

In a further aspect, paint pigments are admixed to the coating where the admixed paint pigments are also heat-resistant. For example, black or other dark pigments can be used to increase the absorption of radiation, resulting in improved heat dissipation.

In a further aspect, metallic pigments are admixed to the coating. Such metallic pigments serve to increase the degree of reflection, leading to a reduction in component temperature, in turn resulting in the effective prevention of hot-gas corrosion. In addition, the coefficients of thermal expansion of the component and the coating can be conformed to each other through the metallic pigments so that thermal stresses between the coating and the component are reduced.

In a further aspect, ceramic nanoparticles are admixed to the coating. These ceramic nanoparticles increase the lubricity of the coating so that not only is hot-gas corrosion prevented but the friction of the coating is lowered.

In a further aspect, several of the aforementioned types of pigment and particles can be combined with each other.

In one example, an electrode of a spark plug for an internal combustion engine can be provided with the coating. The part of the spark plug, specifically the electrode, can be kept free of carbon buildup so that formation of the ignition spark is not degraded or prevented in any way.

Furthermore, a piston, or a piston ring, for an internal combustion engine can be given the coating. The same applies to inlet or exhaust valves of the internal combustion engine. If carbon is deposited on these components, this has a negative effect on fuel economy and emission of pollutants from the internal combustion engine because of the porosity of the carbon. With moving parts, such as pistons, piston rings, valves, the baked on carbon can be detrimental to their sliding properties and result in galling. In addition, the black carbon causes heating, specifically of the piston from radiant heat, also resulting in the negative effects described. These negative effects are eliminated by the coating so that fuel consumption and emission of pollutants from the internal combustion engine are reduced, which would otherwise be achievable only mixing additives with the fuel. Such additives are expensive and represent an additional burden for the user of a vehicle in which an internal combustion engine is installed.

1. A coating for a component of an internal combustion engine to minimize carbon buildup comprising:
the coating consists of a heat-resistant organic-inorganic hybrid polymer.

2. The coating of claim 1, wherein metallic pigments are admixed to the coating.

3. The coating of claim 1, wherein passivating pigments are admixed to the coating.

4. The coating of claim 1, wherein paint pigments are admixed to the coating.

5. The coating of claim 1, wherein ceramic nanoparticles are admixed to the coating.

6. The coating of claim 1 wherein at least two of metallic pigments, passivating pigments, paint pigments and ceramic nanoparticles admixed to the coating.

7. (canceled)

8. The coating of claim 1 wherein the component comprises:
an electrode of the spark plug.

9. The coating of claim 1 wherein the component comprises:
at least one of a piston and a piston ring for an internal combustion engine provided with a coating.

10. The coating of claim 1 wherein the component comprises:
a piston ring.

11. The coating of claim 1 wherein the component comprises:
at least one of an inlet and an exhaust valve.
